(19) United States
(12) Patent Application Publication
(10) Pub. No.: US 2010/0046707 A1
(43) Pub. Date: Feb. 25, 2010

(54) XRD SCREENING SYSTEM AND METHOD

(76) Inventor: Geoffrey HARDING, Hamburg (DE)

Correspondence Address: General Electric Company;GE Global Patent Operation, PO Box 861, 2 Corporate Drive, Suite 648, Shelton, CT, 06484, US

(21) Appl. No.: 12/194,701

(22) Filed: Aug. 20, 2008

(51) Int. Cl. G01N 23/20

(52) U.S. Cl. 378/70

(57) ABSTRACT

Method and system for distinguishing a special nuclear material from a non-threat, high-density metal using X-ray Diffraction. In one embodiment, an X-ray image of an object is examined to detect those voxels having intense XRD profiles, indicating the presence of a high-Z metal. Second, the XRD profiles of such voxels are examined to find the widths and positions of any bands of momentum that are empty of Bragg diffraction peaks. If no such bands are found, then each XRD profile is uniformly populated with Bragg peaks; and it is determined that a special nuclear material is present. If such bands are found, then at least one XRD profile is not uniformly populated with Bragg peaks; and it is determined that a non-threat, high-Z metal is present.

### BACKGROUND

1. Field of the Invention

The field of the invention relates to radiation-based inspection systems generally, and more particularly to certain new and useful advances in X-ray Diffraction (“XRD”) that enable accurate detection of nuclear materials, of which the following is a specification, reference being had to the drawings accompanying and forming a part of the same.

2. Discussion of Prior Art

Some high-density metals, such as lead (“Pb”), which have a cubic close-packed (“ccp”) space lattice, are also called face-centered cubic (“fcc”) metals. FIG. 1 illustrates a ccp lattice unit cell 100, which is a cube with lattice points 102 at the corners and a lattice point 104 in the center of each face. A lattice point is a point in a set of points that have identical surrounding within a crystal. The surroundings include both the type of atoms around the points and their arrangement. In many (but not all) metals, the lattice points are placed at the centers of the metal atoms.

Other types of high-density metals, such as tungsten (“W”), have a body centered cubic (“bcc”) space lattice, an example of which is shown in FIG. 2. The bcc space lattice 200 of FIG. 2 includes multiple unit cells 202. A space lattice is the set of points, mentioned above, that have identical surroundings within a crystal. Each unit cell 202 is defined by vectors 204 between the lattice points 206. The unit cell 202 commonly selected for a body-centered cubic metal is a cube with a lattice point 206 at each corner and a lattice point 208 in the center of the cube. Although it may not be obvious in FIG. 2, all lattice points within the body-centered space lattice 200 are surrounded by a cube of other lattice points.

Typically, a body-centered cubic metal forms with its metal atoms located at the lattice points 206 of the body-centered cubic space lattice 200.

The orientation of a surface or a plane of interest may be defined by considering how the plane (or indeed any parallel plane) intersects the main crystallographic axes of the object. The application of a known set of rules leads to the assignment of the Miller Indices, (h k l); a set of numbers that quantify the intersection points and thus may be used to uniquely identify the plane or surface of interest.

It is customary to describe unit cells of crystals using the three edge lengths a, b and c together with the three angles: α, β and γ that the edges of the unit cell make with the (arbitrary) Cartesian axes shown in FIG. 1. The cubic arrangement is then characterized by a=b=c=a and α=β=γ=90°.

Some high-density metals, such as uranium (“U”) and plutonium (“Pu”), belong to the class of Special Nuclear Materials (“SNMs”), which is defined as nuclear materials that can undergo an uncontrolled fission reaction when exposed to their own neutron flux. Cargo and/or passenger luggage are routinely inspected for nuclear material(s) to prevent a nuclear device, or its components, from falling into unauthorized hands. X-ray Diffraction (“XRD”) is one example of a known active photon interrogation technique for performing these inspections. However, at the high photon energies needed to achieve adequate penetration of SNMs, and their containers, the angles of scatter are very small (e.g., less than about 5.0 milli-radians (“mr”)). Additionally, because the physical densities of SNMs overlap with those of non-threat metals, density measurements alone cannot accurately distinguish SNMs from non-threat metals.

A long-felt need therefore exists for an improved radiation-based inspection system and method which can accurately detect a presence of a nuclear material in cargo and/or in passenger luggage.

### SUMMARY

These and other disadvantages are addressed by embodiments of the claimed invention, which are directed to a radiation-based inspection system and method that can accurately distinguish nuclear material(s) in an object, such as cargo and/or a piece of passenger luggage, from other non-threat, high-density, high-Z metals, regardless of whether the nuclear material(s) is/are shielded, and particularly in situations where an object's XRD profile has only a modest momentum resolution. As used herein, “Z” is symbol that represents an atomic number of a material. The phrase “high-Z” refers to atomic numbers of about 42 and higher.

Other features and advantages of the disclosure will become apparent by reference to the following description taken in connection with the accompanying drawings.

### BRIEF DESCRIPTION OF THE DRAWINGS

Reference is now made briefly to the accompanying drawings, in which:

FIG. 1 is a diagram of a known cubic close-packed space lattice;

FIG. 2 is a diagram of a known body-centered cubic space lattice;

FIG. 3 is a graph of Bragg diffraction peaks plotted against radiation scatter angles (in milli-radians (“mr”) for lead (“Pb”) and uranium (“U”), illustrating that lead (“Pb”) has a band in which no Bragg diffraction peaks appear, which information is used in an embodiment of the invention;

FIG. 4 is a graph of Bragg diffraction peaks plotted against radiation scatter angles (in milli-radians (“mr”) for tungsten (“W”) and uranium (“U”), illustrating that tungsten (“W”) also has a band in which no Bragg diffraction peaks appear, which information is used in an embodiment of the invention;

FIG. 5 is a flowchart illustrating an embodiment of a method for distinguishing nuclear material(s) from other high-Z metals (or high-Z species) using a XRD profile of an object, which XRD profile has a modest momentum resolution;

FIG. 6 is a schematic that illustrates an embodiment of a radiation-based inspection system, which is configured to perform an embodiment of the method illustrated in the flowchart of FIG. 4; and

FIG. 7 is a diagram illustrating the radius dependence on azimuthal angle Φ, of a secondary collimator of spiral form for use in an embodiment of a multi-angle, multi-voxel, MeV-energy XRD system.

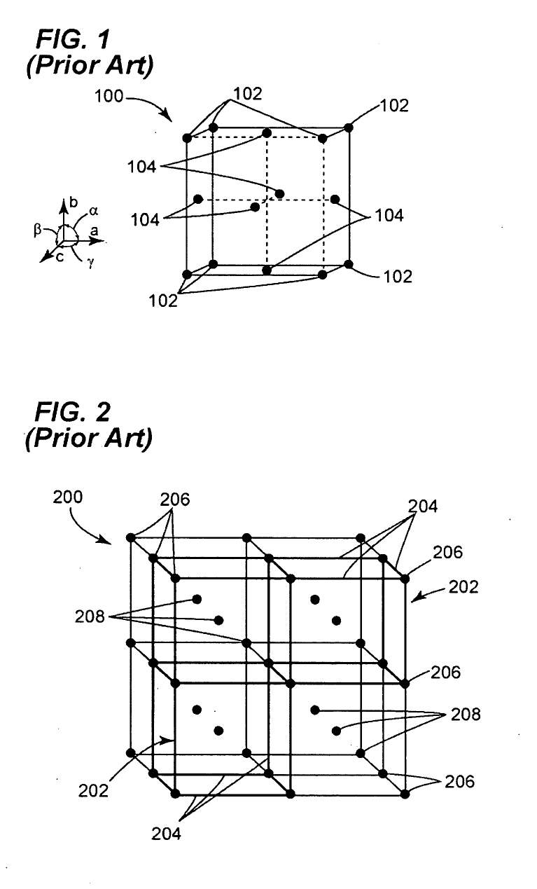

Like reference characters designate identical or corresponding components and units throughout the several views, which are not to scale unless otherwise indicated.

### DETAILED DESCRIPTION

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

Embodiments of the invention use a new X-ray Diffraction (“XRD”)-based inspections system and method, and have their genesis in the discovery that the space lattices of nuclear materials, such as uranium (“U”) and plutonium (Pu”), differ greatly from the space lattices of other non-threat, high-density, high-Z metals.

Table 1 reproduces the densities and crystal structures of all elements of the Periodic Table whose density exceeds 10⁴ kg m⁻³. The table is exclusively populated with high-density, high-Z metals; and the special nuclear materials uranium (“U”) and plutonium (“Pu”) appear in the final two rows. It was surprising to discover from Table 1 that the crystal structures of all non-threat metals are cubic; and that the crystal structures of all nuclear materials are non-cubic. As mentioned, this realization contributed to the discovery and development of embodiments of the invention herein described and claimed.

TABLE 1
Crystal Structures For All Elements of Periodic Table
Whose Density Exceeds 10⁴ kg m⁻³

| | Z | | | |
|---|---|---|---|---|
| | (Atomic | | Density | Crystal |
| Metal | Number) | Symbol | (kg m⁻³⁾ | Structure |
| Molybdenum | 42 | Mo | 10280 | Cubic (bcc) |
| Silver | 47 | Ag | 10490 | Cubic (ccp) |
| Tantalum | 73 | Ta | 16650 | Cubic (bcc) |
| Tungsten | 74 | W | 19250 | Cubic (bcc) |
| Iridium | 77 | Ir | 22650 | Cubic (ccp) |
| Platinum | 78 | Pt | 21090 | Cubic (ccp) |
| Gold | 79 | Au | 19300 | Cubic (ccp) |
| Lead | 82 | Pb | 11340 | Cubic (ccp) |
| Uranium | 92 | U | 19050 | Orthorhombic |
| Plutonium | 94 | Pu | 19816 | Monoclinic |

Referring to Table 1, the unit cell of uranium (“U”) is orthorhombic. For comparison the dimensions of the unit cell of lead (“Pb”) are also given there. (The monoclinic structure of the alpha phase of room temperature elemental plutonium (“Pu”) is reproduced in Table 2). The orthorhombic arrangement is similar to cubic arrangement after a transformation in which the cubic space lattice is stretched by different degrees along two of the three perpendicular axes.

Table 2 lists the cell parameters for uranium (“U”), plutonium (“Pu”), and lead (“Pb”), which exemplifies the other types of non-threat, high-Z materials listed in Table 1. Lengths a, b, and c are expressed in nanometers (“nm”), and angles α, β, γ are expressed in degrees.

TABLE 2
Cell Parameters for Uranium and Plutonium together with Lead

| | a | b | c | α | β | γ |
|---|---|---|---|---|---|---|
| Uranium | 285.4 | 586.9 | 495.5 | 90 | 90 | 90 |
| Plutonium | 618.3 | 482.2 | 1096.3 | 90 | 101.8 | 90 |
| Lead | 495.1 | 495.1 | 495.1 | 90 | 90 | 90 |

Bragg's law is 2 d sin θ=nλ, where λ is the wavelength of the x-ray(s) that penetrates an object, θ is the angle at which the X-ray(s) elastically scatter from the object, d is a distance between parallel lattice planes, and n is an integer that represents an order of the diffraction peak. In one embodiment, λ is the photon wavelength in nanometers (“nm”) equal to 1.24/E, where E is the photon energy expressed in keV. Hence, λ for 1 MeV photons, for example, is 1.24 pm. Bragg's law can be restated as:

nλ=2 d sin θ Equation 1

Bragg diffraction peaks appear when x-rays scattered by the space lattice of an object create constructive interference.

For cubic structures, the d spacings are related to the Miller indices, h, k and l by the following equation, in which a is the side length:

$$\frac{1}{{d}^{2}} = \frac{( {h}^{2} + {k}^{2} + {l}^{2} )}{{a}^{2}} \qquad Equation 2$$

Combining Equation 1 with Equation 2 leads to the following:

$${sin}^{2} θ = ( \frac{{λ}^{2}}{4} ) \cdot \frac{( {h}^{2} + {k}^{2} + {l}^{2} )}{{a}^{2}} \qquad Equation 3$$

Knowledge of the photon wavelength, λ, the edge length, a, and the values of the Miller indices for which diffraction is allowed permits calculation of the angles at which Bragg diffraction peaks occur.

Equation 3 becomes for orthorhombic structures, in which the three side lengths are a, b, and c:

$${sin}^{2} θ = ( \frac{{λ}^{2}}{4} ) \cdot ( \frac{{h}^{2}}{{a}^{2}} + \frac{{k}^{2}}{{b}^{2}} + \frac{{l}^{2}}{{c}^{2}} ) \qquad Equation 4$$

It is apparent from Equation 3 and Equation 4 that, whereas the reflections from the (100), (010) and (001) planes occur in cubic structures at the same angle, θ, these reflections lose their degeneracy in orthorhombic crystals and are separately resolved at different angles. Accordingly, it has been discovered that an orthorhombic crystal will have significantly more Bragg diffraction peaks than a cubic crystal; and this difference provides a simple means of distinguishing between the two.

Not all lattice planes that satisfy Equation 2 contribute to the XRD pattern. There are several conditions regarding the Miller Indices, h, k, and l that must be satisfied for constructive interference to occur. For ccp or fcc, this relation is that the h, k, and l values of a plane are either all even or all odd, but not mixed. Hence, for example, the allowed Miller indices for lead are: (111), (200), (220), etc. By contrast, the non-cubic structures of uranium and plutonium mean that their XRD profiles are much more densely populated with diffraction peaks than their cubic neighbors in the periodic table, whether fcc (e.g., lead (“Pb”)) or bcc (e.g., tungsten (“W”)).

Table 3 shows the Miller indices and Bragg angles for lead (“Pb”), calculated on the basis of its fcc structure with the corresponding selection rules. In the spirit of this article, the Bragg angles are calculated from Equation 3 using the cell parameters from Table 2 for a photon energy of 1 MeV. The final column tabulates the Bragg scatter angle θ in milliradians corresponding to a photon energy of 1 MeV.

TABLE 3
Bragg Line Number, Miller Indices, and
Bragg Scatter Angles For Lead (“Pb”)

| Line | | | | |
|---|---|---|---|---|
| number | h | k | l | Theta |
| 1 | 1 | 1 | 1 | 2.17 |
| 2 | 2 | 0 | 0 | 2.50 |
| 3 | 2 | 2 | 0 | 3.54 |
| 4 | 3 | 1 | 1 | 4.15 |
| 5 | 2 | 2 | 2 | 4.34 |
| 6 | 4 | 0 | 0 | 5.01 |
| 7 | 3 | 3 | 1 | 5.46 |
| 8 | 4 | 2 | 0 | 5.60 |
| 9 | 4 | 2 | 2 | 6.13 |
| 10 | 3 | 3 | 3 | 6.51 |
| 11 | 4 | 4 | 2 | 7.51 |
| 12 | 4 | 4 | 4 | 8.68 |

For the case of uranium the selection rules are much more complicated.

Table 4 shows the Miller indices and Bragg angles for the first 12 Bragg diffraction peaks of uranium (“U”), calculated on the basis of its fcc structure with the corresponding selection rules. The final column tabulates the Bragg scatter angle θ in milliradians corresponding to a photon energy of 1 MeV.

TABLE 4
Bragg Line Number, Miller Indices, and
Bragg Scatter Angles For Uranium (“U”)

| Line number | h | k | l | Theta |
|---|---|---|---|---|
| 1 | 0 | 2 | 0 | 2.11 |
| 2 | 1 | 1 | 0 | 2.42 |
| 3 | 0 | 2 | 1 | 2.46 |
| 4 | 0 | 0 | 2 | 2.50 |
| 5 | 1 | 1 | 1 | 2.72 |
| 6 | 0 | 2 | 2 | 3.28 |
| 7 | 1 | 1 | 2 | 3.48 |
| 8 | 1 | 3 | 0 | 3.84 |
| 9 | 1 | 3 | 1 | 4.04 |
| 10 | 0 | 4 | 0 | 4.23 |
| 11 | 0 | 2 | 3 | 4.31 |
| 12 | 2 | 0 | 0 | 4.34 |

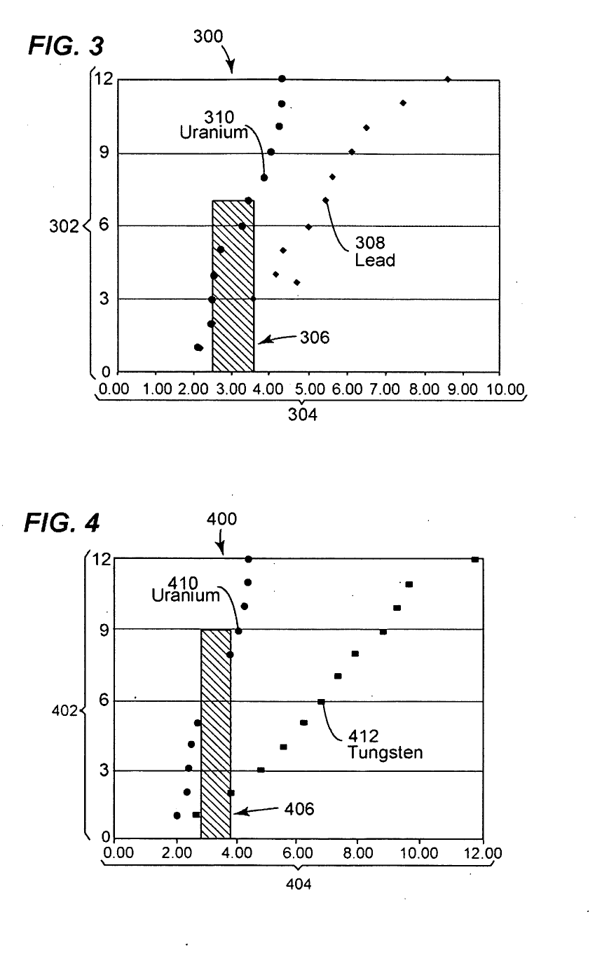

Recalling that for cubic crystals the order of the indices does not affect the Bragg angle, it is interesting to note the occurrences of the (020), (002) and (200) reflections at the beginning, middle and end of this list. A pictorial representation of the results of Table 3 and Table 4 is provided by FIGS. 3 and 4.

FIG. 3 is a graph 300 of Bragg diffraction peaks 302, also called “Bragg lines,” plotted against radiation scatter angles 304 in milli-radians (“mr”) for lead (“Pb”) 308 and uranium (“U”) 310, illustrating that lead (“Pb”) has a band 306 in which no Bragg diffraction peaks appear. In an embodiment of the invention, detection of the band 306 enables a computer processor to distinguish a shielded or unshielded, nuclear material from a non-threat, high-density, high-Z metal. The graph 300 compares the angular positions of the first twelve (12) XRD Bragg diffraction peaks of lead (“Pb”) with those of uranium (“U”) for a photon energy of 1 MegaVolt (“MeV”). As mentioned, lead (“Pb”) has a broad band 306 of momentum around 3 mr in which Bragg diffraction peaks are forbidden. The band 306 ranges from about 2.5 mr to about 3.5 mr, and includes these limits and all subranges therebetween.

FIG. 4 is a graph 400 of Bragg diffraction peaks 402 plotted against radiation scatter angles 404 (in milli-radians (“mr”) for tungsten (“W”) 412 and uranium (“U”) 410, illustrating that tungsten (“W”) 412 also has a band 406 of momentum in which no Bragg diffraction peaks appear. The graph 400 compares the angular positions of the first twelve (12) XRD Bragg diffraction peaks of tungsten (“W”) 412 with those of uranium (“U”) 410 for a photon energy of 1 MegaVolt (“MeV”). As the graph 400 shows, tungsten (“W”) has a broad band 406 of momentum around 3.7 mr in which Bragg diffraction peaks are forbidden. The band 406 ranges from about 2.7 mr to about 3.9 mr, and includes these limits and all subranges therebetween.

The graphs 300 and 400 and their values are illustrative only, and are not drawn to scale. Thus, the boundaries of the bands 306 and 406 are not to be limited by the visual depictions in FIGS. 3 and 4, respectively, but are rather to be mathematically calculated in accordance with the principles of the invention.

Reviewing the graphs 300 and 400, it is noteworthy that all non-threat, high-Z metals have a cubic structure, whether simple cubic, face centered cubic or body centered cubic, and thus have XRD profiles with broad bands 306, 406 that are devoid of Bragg diffraction peaks compared to uranium (“U”) or plutonium (“Pu”).

Other non-threat, high-density metals in Table 1 also have broad bands of momentum in which no Bragg diffraction peaks are present; and a skilled artisan, applying the processes described above can—without undue experimentation—extrapolate tile graphs for these other non-threat, high-density metals to determine the boundaries of these broad bands in which no Bragg diffraction peaks appear. Thus, in addition to distinguishing uranium (“U”) and/or plutonium (“Pu”) from lead (“Pb”) and tungsten (“W”), embodiments of the invention can also distinguish uranium (“U”) and/or plutonium (“Pu”) from one or more non-threat metals, including—but not limited to—molybdenum (“Mo”), silver (“Ag”), tantalum (“Ta”), iridium (“Ir”), platinum (“Pt”), or gold (“Au”).

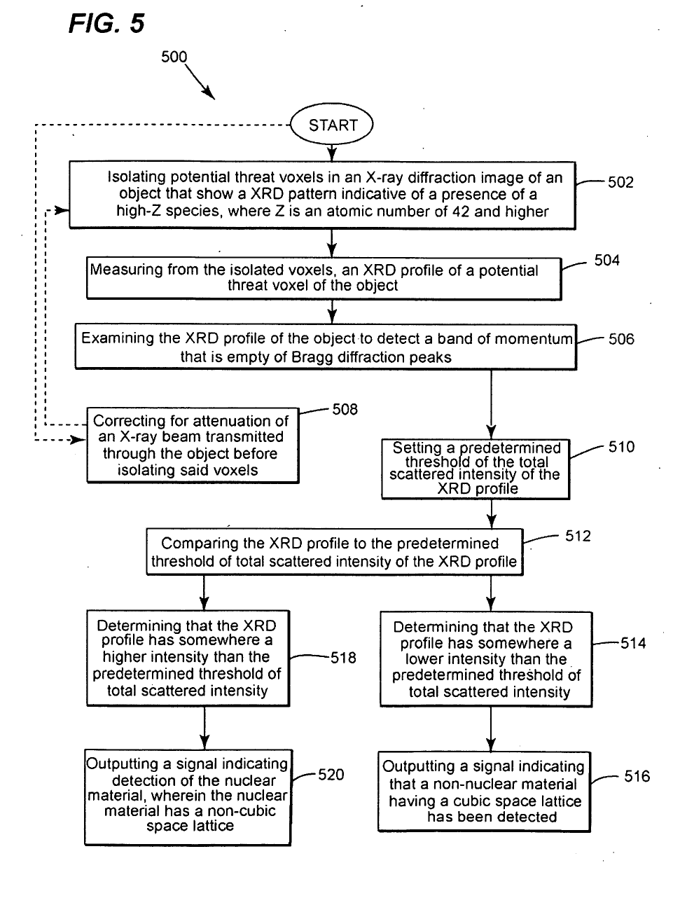

FIG. 5 is a block diagram of an embodiment of a computer-implemented method 500 for distinguishing a nuclear material, such as—but not limited to—uranium (“U”) or plutonium (“Pu”), from a non-threat, high-density metal.

Embodiments of the method 500 are used to distinguish nuclear material(s), and/or SNMs, from other non-threat, high-Z metals using XRD patterns that have only modest momentum resolution (e.g., about 20%). In one embodiment, the method 500 begins by isolating 502 potential threat voxels in an X-ray diffraction image of an object that show a XRD pattern indicative of a presence of a high-Z metal, where Z is an atomic number of about 42 and higher. The method 500 further includes measuring 504 an XRD profile of a potential threat voxel of the object; and thereafter examining 506 the XRD profile of the object to detect a band of momentum that is empty of Bragg diffraction peaks. In an embodiment, the potential threat voxel of the object is selected from the previously isolated set of potential threat voxels. Alternatively, the method 500 begins by correcting 508 for attenuation of an X-ray beam transmitted through the object before isolating said potential threat voxels.

In an embodiment, the examining 506 a XRD profile of the object to detect a band of momentum that is empty of Bragg diffraction peaks further includes setting 510 a predetermined threshold of the total scattered intensity of the XRD profile; and comparing 512 the XRD profile to the predetermined threshold of total scattered intensity of the XRD profile.

The predetermined threshold of total scattered intensity is experimentally determined, and will vary depending on the type of threat object. For example, the predetermined threshold of intensity can be calculated by X-ray diffraction imaging known types of threat objects, such as Uranium (“U”) and Plutonium (“Pb”), correcting for attenuation, storing the XRD profiles of the known types of threat objects in a database, and determining the total scattered intensity for each of the stored XRD profiles of the known threat objects. In an embodiment, the predetermined threshold of intensity is one of the determined total scattered intensities or is one of an average of the determined total scattered intensities. Consequently, the predetermined threshold of total scattered intensity is dynamic in that its value can change and its degree of accuracy can improve each time a threat object is imaged via X-ray diffraction.

In an embodiment, the method 500 further includes determining 514 that the XRD profile has somewhere a lower intensity than the predetermined threshold of total scattered intensity; and outputting 516 a signal indicating that a non-nuclear material having a cubic space lattice has been detected.

In the method 500, the space lattice is one of face-centered cubic (“fcc”) or body-centered cubic (“bcc”).

In an embodiment, the method 500 further includes determining 518 that the XRD profile has somewhere a higher intensity than the predetermined threshold of total scattered intensity; and outputting 520 a signal indicating detection of the nuclear material, wherein the nuclear material has a non-cubic space lattice. In an embodiment, the non-cubic space lattice is orthorhombic, and the nuclear material is uranium (“U”). In another embodiment, the non-cubic space lattice is monoclinic, and the nuclear material is plutonium (“Pu”).

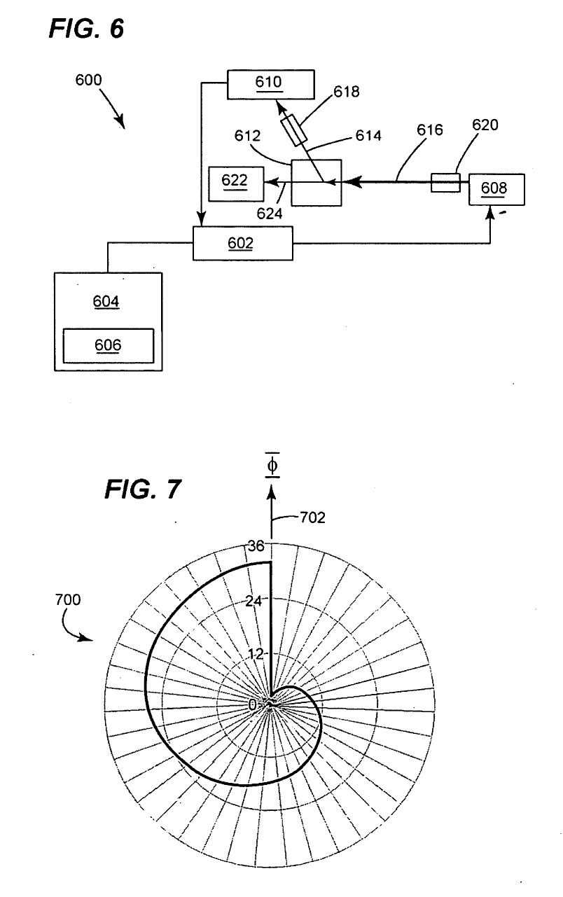

FIG. 6 is a schematic illustrating components of an exemplary embodiment of a radiation-based inspection system 600 configured to perform embodiments of the method 500 of FIG. 5. In an embodiment the radiation-based inspection system 600 is an X-ray Diffraction (“XRD”) scanner, configured to actively interrogate cargo and/or a piece of passenger luggage with photons.

Referring to FIG. 6, an embodiment of the radiation-based inspection system includes a computer processor 602, a memory 604 coupled with the computer processor 602, program instructions 606 stored in the memory 604, as well as a radiation source 608 and a radiation detector 610 positioned to receive scattered X-rays 614 of wavelength λ scattered at an angle θ from the space lattice of an object 612. A secondary collimator 618 may be positioned between the object 612 and the radiation detector 610. A primary collimator 620 may be positioned between the radiation source 608 and the object 612. The scattered X-rays 614 result from X-rays 616 emitted by the radiation source 608, which penetrate the object 612. The object 612 may be cargo, a piece of passenger luggage, or other type of object capable of concealing a nuclear material. Non-limiting examples of the computer-readable memory 604 include: Random Access Memory (“RAM”) and variants thereof, Read-Only Memory (“ROM”) and variants thereof, Flash Memory and variants thereof, optical storage devices, and the like.

Referring to FIG. 6, the computer processor 602 accesses, reads, loads, and executes program instructions 606 stored in the memory 604, which as mentioned, is accessible and readable by the computer processor 602 or other programmable apparatus. The program instructions 604 implement the functions represented by each block, or combination of blocks, depicted in FIG. 5. Means or devices that perform a series of operational steps that implement the functions specified in an embodiment of the method 500 are created when the program instructions 606 execute on the computer processor 602 or other programmable apparatus.

Embodiments of the novel x ray diffraction imaging (XDI) system described herein address some of the challenges of performing XRD at photon energies around 1 MeV, needed to ensure adequate penetration of cargo. To these challenges belongs the lack of a monochromatic x ray source, obliging the use of energy dispersive XRD at a constant scatter angle in the range of a few milliradians.

In an embodiment of the new XRD-based inspection system 600 described herein a high-energy, electron impact X-ray source 608 delivers a well collimated primary beam of approximately 1.0 mm diameter into the object 612 under investigation. In an embodiment, the primary collimator 620 is a thick block of high-Z material containing a bore hole of this diameter. The transmitted X-ray beam 624 is measured in a separate transmission detector 622, thus permitting an attenuation correction of the low angle XRD coherent scatter to be performed. These exemplary technical characteristics can differ in other embodiments of the invention.

At the time of filing, the highest energy continuous current (non-pulsed) electron impact X-ray source of which the inventor is aware is currently under development by Comet AG of Switzerland. It is said to be capable of 4 kW at 800 kV potential; and further increases in the maximum photon energy appear feasible. Higher energy pulsed x-ray sources are also known. Their pulsed x-ray Outputs may also be used for energy-dispersive XRD analysis, although at the expense of longer measurement times. Thus, in one embodiment of the invention, an X-ray source is a continuous X-ray source. In another embodiment of the invention, the X-ray source is a pulsed X-ray source.

Turning again to exemplary types of detectors 610 and scatter collimators 608 that may be used, the momentum transfer parameter, x, is defined as:

$$x = \frac{sin ( \frac{θ}{2} )}{λ} \qquad Equation 5$$

Recalling that the angles are very small, the momentum width, δx, of an intrinsically narrow XRD peak as measured in energy dispersive XRD is:

$$δ x = x \cdot \sqrt{{( \frac{δθ}{θ} )}^{2} + {( \frac{δ E}{E} )}^{2}} \qquad Equation 6$$

In this equation, δθ is the angular range subtended by the collimator at the scattering voxel and δE is the detector energy resolution. As far as the detector is concerned, there is currently significant technical development of so called “photon tracking detectors”, in which the trajectory of a single high energy photon, which is multiply scattered throughout the volume of a large semiconductor crystal, is tracked. Such detectors used with MeV energy photons offer sub-mm, 2-D spatial resolution of the photon incidence coordinates, combined with high detective quantum efficiency (DQE) and good spectral energy resolution. They are thus an appropriate choice for embodiments of the XRD-based inspection system 600.

Equation 6 shows that the angular resolution of the scatter collimator 618 must be on the order of about 20% of the chosen scatter angle if the XRD profile resolution of this magnitude is to be achieved. By way of a non-limiting example, an angle of scatter of 3 mr appropriate for 1 MeV photons corresponds to a deflection of 6 mm over a path length of 2 m. Thus, in this example, the secondary collimator aperture must be approximately 1.0 mm wide. In one embodiment, a spiral slit secondary aperture is used, having a slit width of approximately 1 mm and centered on the primary beam axis to code both the origin point of the scatter ray 614 and its scatter angle θ onto the radiation detector 610.

In one embodiment, the radiation detector 610 is a 2-D spatially resolving detector, which is centered on an axis of the primary beam 616 at a predetermined distance, e.g., about 1 m, from the radiation source 608 behind, i.e., away from, the secondary collimator 618. In such an embodiment, a scattered ray 614, from a certain object voxel will irradiate a spiral band of pixels at the radiation detector 610, each pixel corresponding to a different scatter angle θ. Further, a voxel closer to the radiation source 608 will also irradiate a spiral band of pixels having smaller mean radius at the detector, thus corresponding to smaller angles of scatter. In this way the radiation detector 610 codes three dimensions of information about the incident scatter photons: first, the coordinate of their origin voxel along the primary beam; second, their angle of scatter; and third, their energy.

The relation between angle of scatter and coordinate of origin voxel is illustrated in FIG. 7, which is a diagram 700 illustrating the radius dependence on azimuthal angle Φ, of a secondary collimator 618 of spiral form for use in an embodiment of a multi-angle, multi-voxel, MeV-energy XRD system. In the diagram 700, Φ is zero on the vertical upward axis 702 and advances in increments of 10° in a clockwise direction.

As the diagram 700 shows, the energy dispersive XRD profile of each voxel is recorded at a multiplicity of scatter angles. As the energy and angle of each photon are known it is possible to determine for each the momentum transfer (Equation 1) and thus to synthesize the XRD profile from each voxel along the primary X-ray beam 616. Moreover the multiplicity of angles allows complete XRD profiles using only the highest energy scatter photons to be constructed. Thus the effect of photon attenuation within the cargo or piece of passenger luggage can be minimized.

It should be noted that the original XRD powder pattern measurement of uranium was performed by Jacob and Warren, “The Crystalline Structure of Uranium,” J. Amer. Chem. Soc., 59, 2588-2951, (1937).

A technical effect afforded by embodiments of the invention is the accurate detection of a nuclear material in a container using X-ray diffraction images of the container combined with calculation and detection of a band of momentum that is devoid of Bragg lines.

This written description uses examples to disclose embodiments and principles of the invention, including the best mode, and also to enable any person skilled in the art to make and use embodiments of the invention without undue experimentation. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Although specific features of the claimed invention are shown in some drawings and not in others, this is for convenience only as a feature in one drawing may be combined with any or all of the other features in the same or other drawings, in accordance with the principles of the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the scope of the following claims.

What is claimed is:

1. A method for distinguishing a nuclear material from another metal, the method comprising:
isolating potential threat voxels of an object from an X-ray diffraction image whereby said voxels show an XRD pattern indicative of a presence of a high-Z metal, where Z is an atomic number of 42 and higher;
measuring an XRD profile of a potential threat voxel of the object selected from the isolated potential threat voxels; and
examining the XRD profile of the potential threat voxel of the object to detect a band of momentum that is empty of Bragg diffraction peaks.

2. The method of claim 1, further comprising:
correcting for attenuation of an X-ray beam transmitted through the object before isolating said potential threat voxels.

3. The method of claim 1, wherein the examining a XRD profile of the object to detect a band of momentum that is empty of Bragg diffraction peaks further comprises:
setting a predetermined threshold of total scattered intensity; and
comparing the XRD profile to the predetermined threshold of total scattered intensity.

4. The method of claim 3, further comprising:
determining that the XRD profile has somewhere a lower intensity than the predetermined threshold of intensity; and
outputting a signal indicating that a non-nuclear material having a cubic space lattice has been detected.

5. The method of claim 4, wherein the cubic space lattice is face-centered-cubic (“fcc”).

6. The method of claim 4, wherein the cubic space lattice is body-centered-cubic (“bcc”).

7. The method of claim 3, further comprising:
determining that the XRD profile has somewhere a higher intensity than the predetermined threshold of intensity; and
outputting a signal indicating detection of the nuclear material, wherein the nuclear material has a non-cubic space lattice.

8. The method of claim 7, wherein the non-cubic space lattice is orthorhombic.

9. The method of claim 7, wherein the non-cubic space lattice is monoclinic.

10. The method of claim 1, wherein the nuclear material is shielded.

11. The method of claim 1, wherein the nuclear material is a special nuclear material.

12. The method of claim 1, wherein the nuclear material is a shielded special nuclear material.

13. The method of claim 1, wherein the object is one of cargo and a piece of luggage.

14. An inspection system configured to distinguish a nuclear material from another metal, the inspection system comprising:
a radiation detector configured to output signals indicative of radiation scattered from an object;
a computer processor configured to process the signals output from the radiation detector to create an X-ray image of the object; and
a memory containing computer-readable instructions, that when executed by the computer processor cause the computer processor to:
isolate voxels in a X-ray image of the object that show a XRD pattern indicative of a presence of a Z species, where Z is an atomic number of 42 and higher;
create from the isolated voxels a XRD profile of the object, and
examine the XRD profile of the object to detect a band of momentum that is empty of Bragg diffraction peaks.

15. The inspection system of claim 14, wherein the computer-readable executable instructions, when executed by the computer processor, further cause the computer processor to:
correct for attenuation of an X-ray beam transmitted through an object.

16. The inspection system of claim 14, wherein the computer-readable executable instructions that when executed by the computer processor to examine the XRD profile of the object to detect a band of momentum that is empty of Bragg diffraction peaks, further cause the computer processor to:
set a predetermined threshold of intensity; and
compare the XRD profile to the predetermined threshold of intensity.

17. The inspection system of claim 16, wherein the computer-readable executable instructions that when executed by the computer processor to compare the XRD profile to the predetermined threshold of intensity, further cause the computer processor to:
determine that the XRD profile has somewhere a lower intensity than the predetermined threshold of intensity; and
output a signal indicating that a non-nuclear material having a cubic space lattice has been detected.

18. The inspection system of claim 17, wherein the cubic space lattice is face-centered-cubic (“fcc”).

19. The inspection system of claim 17, wherein the cubic space lattice is body-centered-cubic (“bcc”).

20. The inspection system of claim 16, wherein the computer-readable executable instructions that when executed by the computer processor to compare the XRD profile to the predetermined threshold of intensity, further cause the computer processor to:
determine that the XRD profile has somewhere a higher intensity than the predetermined threshold of intensity; and
output a signal indicating detection of the nuclear material, wherein the nuclear material has a non-cubic space lattice.

21. The inspection system of claim 14, wherein the object is one of cargo and a piece of passenger luggage.

22. The inspection system of claim 14, wherein the nuclear material is shielded.

23. The inspection system of claim 14, wherein the radiation detector is a 2-D, spatially-resolving detector.

24. The inspection system of claim 23, wherein the 2-D, spatially-resolving detector is configured to code three dimensions of information.

25. The inspection system of claim 24, wherein the three dimensions of information comprise:
a coordinate of each incident scatter photon's origin voxel along a primary beam of radiation;
an angle of scatter for each incident scatter photon; and
an energy of each incident scatter photon.
